(19) United States
(12) Patent Application Publication
(10) Pub. No.: US 2004/0042865 A1
(43) Pub. Date: Mar. 4, 2004

(54) Rotary tool

(76) Inventor: Matthias Oettle, Riederich (DE)

Correspondence Address: Mark S Bicks, Roylance Abrams Berdo & Goodman, Suite 600, 1300 19th Street NW, Washington, DC, 20036, US

(21) Appl. No.: 10/399,472

(22) PCT Filed: Aug. 11, 2001
(86) PCT No.: PCT/EP01/09312

(30) Foreign Application Priority Data
Oct. 20, 2000 (DE) 10052016.2

(51) Int. Cl. B23C 3/00

(52) U.S. Cl. 409/234; 408/124

(57) ABSTRACT

The invention relates to a rotary tool comprising a shank (1) which can be coupled to a rotary drive and comprises a head piece (3) on the free end thereof which can be detachably connected in a bearing arrangement to a cutting body (21). The cutting edge (23) of the cutting body (21) is arranged at a radial distance from the axis of rotation corresponding to a desired cutting circle diameter.

The invention relates to a rotary tool having the characteristics specified in the preamble of claim 1, a drilling or milling cutter in particular.

In a state-of-the art rotary tool disclosed in EP-A-0 296 460 the cutting circle diameter is modified by rotating the cutting element carrier mounted so as to be offset eccentrically from the rotation axis as a function of the torque acting on tool during operation. For this purpose the cutting element carrier is pretensioned by a torsion spring in a first stop position which corresponds to a first cutting circle diameter. Rotation against the action of the torsion spring from this position occurs if the operating torque exceeds a threshold value. This results in automatic setting of different cutting circle diameters for trimming machining processes and for scrubbing, which is carried out with higher operating torque.

DE-U-91 01 149 discloses a generic tool with a locking mechanism by means of which the cutting element carrier may be locked with the head in selected rotary positions which correspond to the desired cutting circle diameter of the cutting edge of the cutting element. The tool disclosed has on one of its ends a tapering mounting shank conforming to DIN (German Industrial Standards) for securing the tool on a metalworking machine, and on the other end the tool is provided with a cutting plate which is mounted in a bracket in the tool resembling a drill rod. The center of the machining diameter of the cutting tools is eccentrically offset from the rotation axis of the tool proper; for the purpose of setting the eccentric offset, diagonal gear elements of the tool holder and of the cutting element carrier are disengaged from the cutting plate, and after rotation about the longitudinal axis of the tool clockwise/counterclockwise, re-engaged with the cutting plate, against the action of a coupling mechanism and accordingly against the force of a pressure spring.

Consequently, the disclosed solution makes it possible, in the case of a rotary tool, not only to adjust the cutting circle diameter between two cutting circle diameters provided for special machining processes, but also rapidly to modify the cutting circle diameter by predetermined adjustment amounts even when small changes are to be made. However, the disclosed solution involves a large number of components which result in correspondingly high space requirements; the unbalanced behavior associated with such components must be overcome in order to achieve good machining accuracies.

In addition, DE-A-33 12 990 discloses provision, in a tool in which a lateral face of a head enclosing a bearing bore is guided on one of the locating faces of the flange of the cutting element carrier, of locking recesses which act in conjunction with a spring-loaded catch element provided in the flange of the cutting element carrier to form rotary catches between cutting element carrier and head, in order thus to adjust the cutting elements held so as to be adjustable to different boring diameters.

On the basis of the generic state of the art the object of the invention is to provide a rotary tool which has a small number of parts and thus may be produced by a simple process and cost-effectively. Another object of the invention is achievement of a low space requirement in order thus to counteract the occurrence of unbalanced conditions generating problems. The object as thus formulated is attained by a rotary tool having the characteristics specified in patent claim 1 as a whole.

In that, as specified in the descriptive portion of claim 1, the cutting element carrier has an opening serving as seat for a cutting plate, which opening extends from the frontal surface of the flange into the bearing journal, and in that means are provided for tensioning the cutting plate, in particular a tightening screw seated in the bearing journal, which screw is accessible from the circumference of the head into the bearing bore when the cutting element carrier is in a selected rotary position, a tool is obtained which is characterized by a low number of components and thus may be produced simply and cost-effectively. Because of the low number of components the structural weight is also low, so that the occurrence of unbalanced conditions creating problems is counteracted to the greatest extent possible.

The value selected for the eccentricity of the adjustment axis in the case of the tool claimed for the invention relative to the tool axis and the value of the radial distance at which the cutting edge of the cutting element is mounted on the cutting element carrier determine the amount of change in the cutting circle diameter per angular unit of rotation of the cutting element carrier relative to the head of the shank. The relationships may be configured by the simplest of means so that a desired precision adjustment of the cutting circle diameter is made on rotation of the cutting element carrier, which is then fixed in the respective rotary position by the locking mechanism against further rotation.

In one advantageous exemplary embodiment the cutting element carrier has for the purpose of forming the rotary bearing on the head of the shank a bearing journal which is mounted in a bearing bore eccentrically relative to the axis of rotation of the shank and suitably rotatably mounted concentrically relative to the head, the cutting edge of the cutting element being mounted eccentrically offset at a radial distance from the axis of the bearing journal.

The tool claimed for the invention may be designed so that the total adjustment range for the cutting circle diameter resulting from rotation of the cutting element carrier over a range of 180° is subdivided into fixed adjustment steps, for example, into adjustment steps of the cutting circle diameter of 0.1 mm or 0.05 mm. A locking mechanism, for example, one in the form of a ball lock, may be provided for this purpose between the cutting element carrier and the head, there being provided on the cutting element carrier a spring-loaded notch ball which may drop into locking recesses which are mounted on the head of the shank so that they effect locking in the rotary steps corresponding to the desired changes in the cutting diameter.

The invention is discussed in detail in what follows on the basis of an exemplary embodiment shown in the drawing, in which

FIG. 1 presents a perspective view of a milling cutter in one exemplary embodiment of the invention;

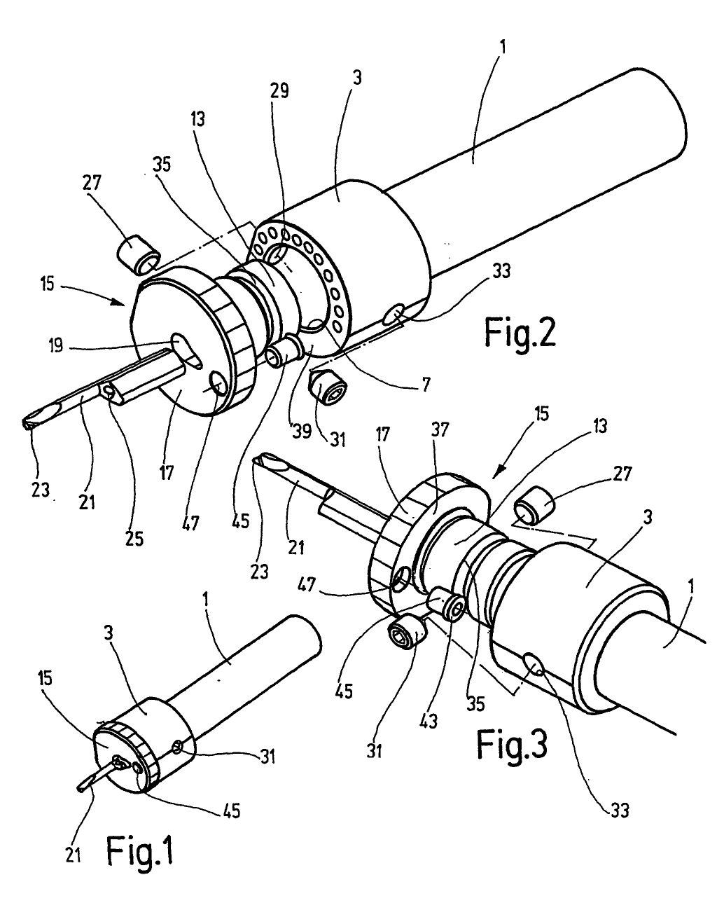

FIGS. 2 and 3 show views of the milling cutter on different and respectively larger scales and in an exploded perspective view, and

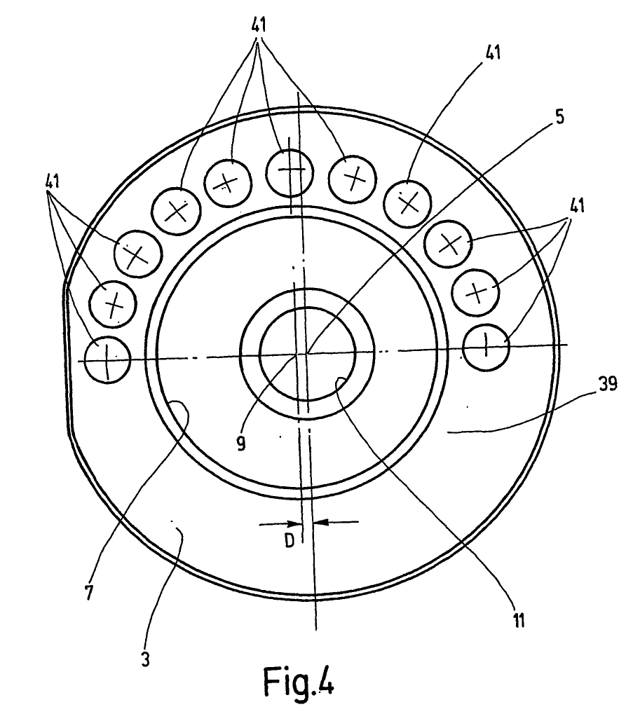

FIG. 4 a top view on an even larger scale of the front end of the head on the tool shank in the exemplary embodiment.

FIG. 1 presents a general view of the exemplary embodiment in the form of a milling cutter as assembled, the tool shank connectible to a rotary drive (not shown) being identified as 1 and a head opposite it of greater diameter molded on the front end of the shank 1 as 3. The circular cylindrical head 3 is concentric with the shank 1, also circularly cylindrical, and the tool rotation axis 5 defined by this shank.

As is to be seen from FIG. 4, the head 3 on the front end of the tool shaft 1 has a bearing bore 7 which is offset eccentrically relative to the rotation axis 5 of the shank 1 at a distance designated as D and which in turn defines the insertion axis 9. As is also to be seen from FIG. 4, there is in the shank 1 an inner through bore 11 which opens out into the bearing bore 7 of the head 3, is concentric with the rotation axis 5 of the shank, and forms a flow channel for coolant delivery.

As is to be seen from FIGS. 2 and 3, the bearing bore 7 forms in the head 3 acting in conjunction with a bearing journal 13 a pivot bearing for a cutting element carrier 15 integral with the bearing journal 13. This carrier has on its end facing the workpiece to be machined a round flange 17 of a diameter greater than that of the bearing journal 13, this flange 17 having on its front end, that is, the end facing the workpiece to be machined, an opening 19 (FIG. 2) for a cutting plate 21 serving as seat for a cutting element. For the purpose of delivery of coolant to the cutting edge 23 of the cutting plate 21, the latter has a through bore 25 (FIG. 2) which, by way of the opening 19 in the flange 17 of the cutting element carrier and a following inner bore of the bearing journal 13 (not shown), extends the delivery channel for the coolant by way of the inner bore 11 in the shank 1.

The cutting plate 21 is secured against rotation in the opening 19 forming its seat by the non-circular shape of the opening 19 adapted to the cutting plate 21 and is fastened axially by means of a locking screw 27 (FIGS. 2 and 3), which is seated in a threaded bore (not shown) of the bearing journal 13 and, as is indicated in FIGS. 2 and 3 by broken lines, is accessible through a radial bore 29 (only indicated in FIG. 2) which is formed in the wall of the head 3 enclosing the bearing bore 7 with the bearing journal 13 and head 3 in a selected rotary position. The bearing journal 13, in turn, may be fixed in the bearing bore 7 by means of a locking screw 31 which is seated in a threaded bore 33 in the wall of the head 3 enclosing the bearing bore 7 and acts in conjunction with the bearing journal 13. The latter has incorporated in it a circular groove 35 which is in alignment with the locking screw 31 when the bearing journal 13 has been introduced into the bearing bore 7. In this configuration the bearing journal 13 is secured in place axially in the bearing bore 7 but is rotatable relative to the head 3 if the locking screw 31 is loosened only to the extent that it still engages the circular groove 35 without exerting a clamping effect.

On the area of transition to the bearing journal 13 the flange 17 of the cutting element carrier 15 forms a locating face 37 positioned in the radial plane; when the tool has been assembled, this locating face 37 is guided on the level edge face 39 of the head 3 delimiting the bearing bore 7 in the rotary movement serving to adjust the cutting circle diameter. Dome-shaped locking recesses 41, evenly distributed over a range of 180°, as is to be seen from FIGS. 2 and 4, are made in the edge face 39 which, together with a spring-loaded locking ball 43 seated in a spring housing 47 which in turn is seated in a perforation 47 in the flange 17, permits rotary locking with the locking recesses 41. In the example illustrated the recesses 41 are arranged so that the rotary movement is divided into ten rotary steps when the cutting element carrier 15 is rotated over the entire range of displacement of 180°.

As FIG. 4 clearly shows, the recesses 41 are distributed at equal distances in a circle concentric with the bearing bore 7 and thus with the insertion axis 9 and eccentric relative to the rotation axis 5, specifically, in the circle which the locking ball 43 describes during rotation of the bearing journal 13 in the bearing bore 7. This rotary movement leads to change in the diameter of the cutting circle of the cutting edge 23 of the cutting element 21 if this element is mounted on the cutting element carrier 15 in a position such that the cutting edge 23 is situated eccentrically a certain radial distance from the cutting insertion axis 9.

If the bearing journal 13 is displaced eccentrically the same distance from the circumference of the flange 17, the distance by which the bearing bore 7 is displaced eccentrically from the rotation axis 5, this distance being identified as D in FIG. 4, then, with the cutting element carrier 15 and head 3 in a relative rotary position, the circumference of the flange 17 is concentric with the circumference of the head 3. This rotary position, which is easily perceived by the user, may then be provided as initial position for the range of adjustment, the circumference of the flange 17 being progressively displaced eccentrically relative to the head 3 as the rotation movement, that is, rotation of the cutting element carrier 15, progresses.

If continuous rotational adjustment is desired, the spring housing 45 with locking ball 43 may be omitted. Markings which indicate the rotational displacement and simplify adjustment may be provided for this purpose on the circumference of the head 3 and on the circumference of the flange 17, in place of the rotary locking or as a supplement to it.

1. A rotary tool with a shank (1) defining the axis of rotation (1) which may be coupled to a rotary drive and has on its free end a head (3) to which is detachably connectible in a positional configuration in which the cutting edge (23) of the cutting element (21) is situated at a radial distance corresponding to the desired cutting circle diameter from the rotation axis (5), and with a cutting element carrier (15) serving as retainer of the cutting element (21), such cutting element carrier (15) being mounted on the head (3) so as to be rotatable about an insertion axis (9) which is parallel to the rotation axis (5) of the shank (1) and offset eccentrically relative to this shank (1), the cutting edge (23) of the cutting element (21) on the cutting element carrier (15) being mountable offset a radial distance from the insertion axis (9), and a locking mechanism (31) being present by means of which the cutting element carrier (15) may be locked with the head (3) in selected rotary positions which correspond to the desired cutting circle diameter of the cutting edge (23) of the cutting element (21), characterized in that the cutting element carrier (15) has an opening (19) serving as seat for a cutting plate (21) and extending from the frontal surface of the flange (17) into the bearing journal (13), and in that there is provided for tensioning the cutting plate (21) tensioning means situated in the bearing journal (13), a locking screw (27) in particular, which is accessible, with the cutting element carrier (15) in a selected rotary position, by a bore (29) extending from the circumference of the head (3) through the bearing bore (7).

2. The tool as claimed in claim 1, wherein the cutting element carrier 15 has, for the purpose of formation of the rotary bearing on the head (3) of the shank (1), a bearing journal (13) which is suitably mounted rotatably in a bearing bore (7) in the head (3) eccentric relative to the rotation axis (5) of the shank (1) and concentric with the insertion axis (9), and wherein the cutting edge (23) of the cutting element (21) is mounted so as to be offset at a radial distance eccentrically relative to the axis of the bearing journal (13).

3. The tool as claimed in claim 2, wherein the locking mechanism contains a locking screw (31) extending through the wall of the head (3) delimiting the bearing bore (7), such locking screw (31) acting in conjunction with the bearing journal (13) of the cutting element carrier (15) present in the bearing bore (7).

4. The tool as claimed in claim 3, wherein the bearing journal (13) of the cutting element carrier (15) has a circular groove (35) made in it, which groove is in alignment with the locking screw (31).

5. The tool as claimed in claim 4, wherein the head (3) has an outer diameter greater than that of the section of the shank (1) acting in conjunction with the rotary drive with an outer jacket surface concentric with the rotation axis (5) and wherein the cutting element carrier (15) has, on the end of the bearing journal (13) facing the cutting edge (23) of the cutting element (21), a flange (17) which forms a locating face (37) adjoining the bearing journal (13) and positioned in the radial plane, which locating face (37) which is guided on the edge face (39) of the head (3) adjoining the bearing bore (7) in the rotary movement serving the purpose of adjusting the cutting circle diameter.

6. The tool as claimed in claim 1, wherein the outer diameter of the flange (17) of the cutting element carrier (15) is adapted to the outer diameter of the outer jacket surface of the head (3) enclosing the bearing bore (7) and wherein the bearing journal (13) if eccentrically from the circumference of the flange (17) at a radial distance which corresponds to the offset (D) of the insertion axis (9) from the rotation axis (5) of the shank (1).

7. The tool as claimed in claim 5 or 6, wherein there are formed in edge face (39) of the head (3) enclosing the bearing bore (7), on the locating face (37) of the flange (17) of the cutting element carrier (15), locking recesses (41) which act in conjunction with a spring-loaded locking ball (43) provided in the flange (17) of the cutting element carrier (15) to form rotary catches between cutting element carrier (15) and head (3).

8. The tool as claimed in one of claims 1 to 7, wherein the shank (1) has an inner longitudinal through bore (11) serving as coolant channel and wherein the bearing journal (13) has an inner bore serving as extension of the coolant channel, which bore extends into the seat (19) of the cutting plate (21).
